(19) United States
(12) Patent Application Publication
(10) Pub. No.: US 2026/0100115 A1
(43) Pub. Date: Apr. 9, 2026

(54) ITEM DETECTION SYSTEM AND METHOD

(71) Applicant: Mashgin Inc., Palo Alto, CA (US)

(72) Inventors: Abhinai Srivastava, Palo Alto, CA (US); Mukul Dhankhar, Palo Alto, CA (US)

(73) Assignee: Mashgin Inc., Palo Alto, CA (US)

(21) Appl. No.: 19/351,021

(22) Filed: Oct. 6, 2025

Related U.S. Application Data
(60) Provisional application No. 63/703,497, filed on Oct. 4, 2024.

(51) Int. Cl. G07G 1/00; G06V 10/26; G07G 1/01

(52) U.S. Cl. CPC G07G 1/0063; G06V 10/26; G07G 1/0018; G07G 1/01

(57) ABSTRACT

In variants, the system can include a base and a set of supports cooperatively defining an measurement volume, and a processing system configured to identify items places within the measurement volume.

### CROSS-REFERENCE TO RELATED APPLICATIONS

This application claims the benefit of U.S. Provisional Application No. 63/703,497 filed 04-OCT-2024, which is incorporated in its entirety by this reference.

### TECHNICAL FIELD

This invention relates generally to the item identification field, and more specifically to a new and useful system and method for item identification.

### BRIEF DESCRIPTION OF THE SEVERAL VIEWS OF THE DRAWINGS

FIG. 1 is a flowchart representation of a variant of the method.

FIG. 2 is a schematic representation of a variant of the system.

FIG. 3 is a schematic representation of a variant of the system FIG. 4 is an illustrative example of the sampling system.

FIG. 5 is an illustrative example of an optical sensor coupled with a support.

FIG. 6 is an illustrative example of determining an item identifier.

FIG. 7 is an illustrative example of identifying a batch of items.

FIG. 8 is an illustrative example of the sampling system.

FIG. 9 is an illustrative example of the sampling system.

FIG. 10 is an illustrative example of the sampling system.

### DETAILED DESCRIPTION OF THE INVENTION

The following description of the embodiments of the invention is not intended to limit the invention to these embodiments, but rather to enable any person skilled in the art to make and use this invention.

### 1. Overview

In variants, the system includes: a sampling system 100; an optional set of repositories 200; an optional set of point of sale (POS) systems; and an optional set of models. In variants, the method can include: determining a set of measurements S100; identifying a set of items based on the set of measurements S200; determining payment information for the set of items S300; and completing a transaction based on the payment information S400. The system and/or method can function to provide a modular, lightweight concurrent checkout system.

In an illustrative example, the system can include: a set of supports geometrically defining an open-sided measurement volume (e.g., with an unobstructed top, at least three unobstructed sides, etc.); a set of optical sensors mounted to the set of supports, wherein the fields of view of the optical sensors collectively define an optically enclosed space, wherein the measurement volume is located within the optically enclosed space; and a base mounting the set of supports and optionally including a display. In variants, the system can: receive a set of objects within the measurement volume; sample a set of measurements of the objects with the set of optical sensors; optionally segment out individual objects (e.g., by identifying a geometric feature, such as a neck, in a perspective view of the geometric measurement or height map, and segmenting the measurements using a planar cut through the neck); extract a set of morphology embeddings for each object from the set of measurements (e.g., appearance or color embeddings, geometry embeddings, etc.); and identify the set of objects based on the set of morphology embeddings (e.g., by matching the extracted embeddings to morphology embeddings known objects or clusters thereof). In variants, the method can optionally detect that the objects have been stacked (e.g., when the geometric embeddings deviate from known embeddings beyond a predetermined threshold), and optionally warn the user to unstack the objects, trigger a vertical segmentation algorithm (e.g., identify a geometric feature, such as a neck, in a side view of the geometric measurement and segment using a planar cut through the neck) and individually identify the resultant segments, and/or otherwise manage stacked objects.

However, the system and/or method can be otherwise configured.

Variants of the technology can confer one or more advantages over conventional technologies.

First, variants of the technology can provide the flexibility of physically open configuration but an optically enclosed space, which enables high-accuracy item identification while enabling multidirectional access of the measurement volume. This can enable more use cases for the sampling system, such as bidirectional user access for bidirectional self-checkout (e.g., wherein users on both the front and back or left and right sides of the sampling system can use the system for checkout); cashier-assisted checkout (e.g., wherein the cashier can face the customer); and/or other use cases.

Second, variants of the technology can achieve more accurate object detection by tracking item state and adding motion information to object detection algorithms, enabling the system to maintain object identity as items move through the measurement volume. The system can perform segmentation while objects are moving into the measurement volume, rather than waiting until motion ceases. In a specific example, the technology can utilize temporal tracking algorithms that correlate object features across multiple frames, allowing continuous identification even during dynamic positioning. This approach can reduce processing time and improve user experience by eliminating the need for items to remain stationary during measurement, while simultaneously reducing identification errors that may occur when multiple similar objects are present in the measurement volume.

Third, variants of the technology can increase usability by allowing multiple batches items to be included in a single transaction or checkout session. This capability can be particularly beneficial when a single user is paying for items for a group of users (e.g., a parent purchasing for family members, wherein each family member has their own batch of items or tray of food), when the user wants to purchase more items than will simultaneously fit within the measurement volume, and in other situations requiring flexible transaction management. Multi-batch checkout can address limitations of static measurement volumes with finite capacity by accruing charges for multiple sets of items against the same invoice and completing the transaction when a checkout confirmation is determined. In variants, the payment information can be received before all items have been identified and stored for final payment processing after all items have been measured and catalogued, thereby improving transaction efficiency and customer satisfaction.

However, further advantages can be provided by the system and method disclosed herein.

### 2. System

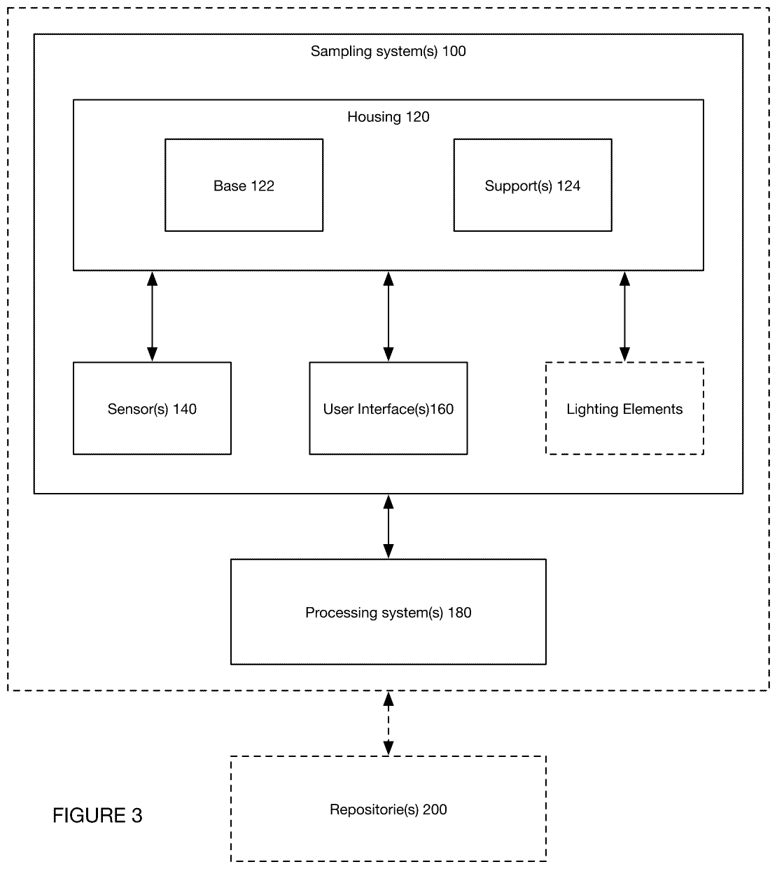

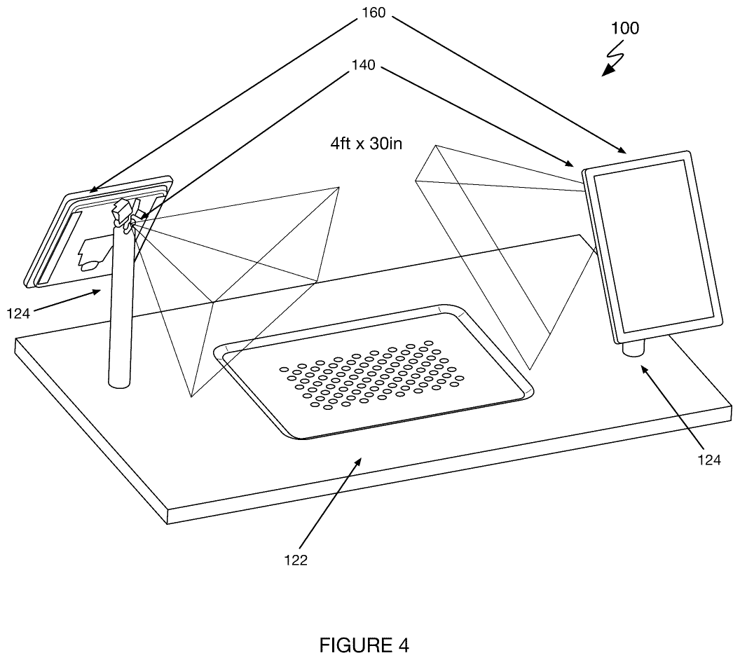

In variants, the system can include: a sampling system 100; an optional set of repositories 200; an optional set of point of sale (POS) systems; and an optional set of models. The sampling system 100 functions to sample one or more measurements of one or more items. An example is shown in FIG. 3.

The set of items used with the sampling system 100 can include: consumables, durables, commercial item, and/or any other items. The items can include food (e.g., prepared food, packaged food, etc.), beverages (e.g., prepared beverages, packaged beverages, etc.), apparel (e.g., clothing), shoes, accessories, cleaning products, medical supplies, office supplies, electronics, and/or any other item.

The physical item can have or be associated with semantic identifiers or not be associated with semantic identifiers. The semantic identifiers can include machine-readable identifiers, human-readable identifiers, and/or any other identifiers. The physical item can have or be associated with semantic identifiers or not be associated with semantic identifiers. Examples of semantic identifiers can include barcodes (e.g., QR codes, line barcodes, UPCs, etc.), NFC tags, alphanumeric text (e.g., labels, logos, etc.), and/or any other semantic identifier. In an example, all items in a batch of items exclude semantic identifiers. In an example, some items in a batch of items exclude semantic identifiers and some items in a batch of items include semantic identifiers. In an example, all items in a batch include semantic identifiers.

The sampling system 100 can be used by one or more users. In examples, users using the system can include a customer, a cashier, a manager, a merchant, a central entity, and/or any other user. In examples, the same sampling system 100 can support self-checkout, cashier assisted checkout, and/or other checkout modes.

The sampling system 100 is preferably a modular system, but can alternatively be a preconstructed unitary system or otherwise constructed.

A system can include one or more sampling systems 100. The multiple sampling systems 100 can be connected as a fleet or operate individually. Sampling systems 100 that operate as a fleet can share: an item database, be on the same network, be associated with the same entity (e.g., same login credentials), and/or any other capability.

The sampling system 100 is preferably located onsite at a user facility, but can alternatively be at a different venue, and/or any other location. The sampling system 100 can be a retrofit system, stand-alone system, installation, and/or be otherwise configured relative to its environment.

In a first variant, the sampling system 100 can be built into, constructed as a unitary body, recessed into, attached to, retrofitted into, or otherwise integrated into a countertop or other support surface. In a first example of the first variant, the base 122 can be built into, be made from, and/or be recessed into surrounding support surface, such that the base 122 is substantially flush with the support surface. In a second example of the first variant, the supports 124 can include all the computational and sensing components of the sampling system 100, and be installed into a pre-existing counter.

In a second variant, the sampling system 100 can sit on top of the support surface. In an example of the second variant, the sampling system 100 includes a base 122 mounted to a set of supports 124, wherein the sampling system 100 is placed on a counter or other support surface.

In variants, the sampling system 100 can include: a housing 120; a set of sensors 140; an optional set of user interfaces 160; a set of processing systems 180; and an optional set of communication modules.

The housing 120 functions to define a measurement volume and can optionally retain the sensors 140 in a predetermined configuration about the measurement volume. The material of housing 120 can include metal (e.g., aluminum), plastic, wood, and/or any other material.

The sampling system 100 (e.g., housing) preferably defines an optically enclosed space, but can alternatively define an optically open space (e.g., measurement volume is not visually isolated for the sensors 140; the sensor frustums do not intersect; the sensor frustums do not intersect the measurement volume; etc.), and/or define any other optical space. The optically enclosed space can be defined by the collective fields of view of the optical sensors 140 (e.g., cameras, depth sensors, geometric sensors, etc.), and/or otherwise defined.

The sampling system 100 preferably defines a measurement volume with a physically open configuration (e.g., housing 120 does not fully surround the measurement volume), but can alternatively define a measurement volume with any other configuration. The measurement volume is preferably static (e.g., relative to the housing 120, static relative to an ambient environment, etc.), but can alternatively be dynamic (e.g., move in space, change in shape and/or volume, etc.), and/or be otherwise configured.

In an example, the measurement volume is defined by an upward projection of the base 122, geometrically bounded by the supports 124.

In another example, the measurement volume can be defined by the interior surfaces of the sampling system 100 and/or housing 120 (e.g., by the interior surfaces of the supports 124, base 122, etc.), be defined by the region occupied by a set of items, be defined by a region configured to receive a set of items, and/or otherwise defined.

The measurement volume height can be defined by the support height, the sensor field of view height, and/or otherwise defined. The measurement volume height is preferably not physically defined (e.g., bounded) by a physical barrier (e.g., head unit), but can alternatively be defined by a physical barrier.

The measurement volume lateral extent(s) can be defined by the positions of the supports 124 (e.g., be geometrically bounded by the supports 124 ; wherein the supports 124 act as reference markers that define a bounding box for the measurement volume), by the lateral extents of the sensor fields of view, by the intersections of the sensor fields of view, by the lateral extent(s) of the base 122, and/or otherwise defined. The measurement volume lateral extents (e.g., front, back, left, right, etc.) are preferably not physically obstructed (e.g., by a housing 120 or system component), but can alternatively be partially obstructed by a system component (e.g., support 124, user interface 160, etc.) or defined by a system component (e.g., be defined by a support frame).

The sensors' fields of view preferably intersect within the measurement volume, but can alternatively encompass different regions of the measurement volume, and/or otherwise interact with the measurement volume.

In a first example, the housing 120 excludes a top (e.g., a top that can bound the vertical extent of the measurement volume, a top that can control the optical characteristics of the measurement volume such as by blocking ambient light or by supporting lighting systems, etc.).

In a second example, the measurement volume and/or housing 120 is substantially physically unenclosed (e.g., unobstructed; does not include sidewalls and/or a top; is open along at least 2, 3, 4, or 5 sides; etc.).

In a third example, the measurement volume and/or housing 120 is structurally bounded by set of supports 124 (and optionally the user interfaces 160 and/or point of sale systems mounted to the supports 124) but is otherwise unenclosed.

In a fourth example, the measurement volume and/or housing 120 is geometrically bounded by the set of supports 124 and/or the base 122, and is otherwise unenclosed.

In a fifth example, the measurement volume and/or housing 120 encloses less than a threshold percentage of the measurement volume boundary (e.g., less than 30%, less than 10%, less than 5%, etc.).

In a sixth example, the measurement volume and/or housing 120 has less than a threshold number of sides (e.g., no sidewalls, less than 1 sidewall, less than 2 sidewalls, less than 3 sidewalls, no top, less than a threshold proportion of the top is enclosed, etc.). A sidewall can extend along all or a portion of the measurement volume height (e.g., 30%, 40%, 50%, etc.).

In a seventh example, an upward projection of the base 122 is not physically obstructed or is obstructed less than a threshold percentage by other physical housing components (e.g., less than 30%, 20%, 10%, 5%, etc.).

In an eighth example, the supports 124 function as reference markers that define a notional bounding box for the measurement volume in 3D space.

In a ninth example, the measurement volume can be defined by the optical geometry, and not by physical barriers.

In a tenth example, the measurement volume can have unobstructed sides (e.g., unobstructed front, back, left, and/or right sides).

Alternatively, the sampling can have a physically enclosed configuration. In a first example, the housing 120 can fully surround the measurement volume. In a second example, the housing 120 includes a top. In a third example, the housing 120 includes more than a threshold number of sides (e.g., 1 sidewall, 2 sidewalls, 3 sidewalls, a top, etc.).

In variants, the housing 120 includes a base 122 and a set of supports 124.

The base 122 functions as the support structure of the sampling system 100. The base 122 can mount the supports 124, function as a calibration reference for the sensors, support the items, define the base of the measurement volume, and/or perform other functions. A sampling system 100 preferably includes a single base 122, but can alternatively include multiple bases 122, and/or any other bases 122.

The base 122 is preferably static relative to the supports 124 and/or sensors, but can alternatively be dynamic (e.g., mobile, a conveyor belt, etc.). The base 122 can be open (e.g., open air, unobstructed, etc.), enclosed (e.g., partially enclosed, fully enclosed,), and/or otherwise obstructed. The base 122 preferably has a predetermined lateral and/or longitudinal extent (e.g., less than 5 ft, less than 4 ft, less than 3 ft, less than 2 ft, less than 1 ft, etc.), but can alternatively have an unconstrained lateral and/or longitudinal extent. In an example, the base footprint dimensions define (e.g., are substantially equivalent to) the footprint of the measurement volume.

The base 122 can include and/or be a solid color (e.g., black, white, grey, etc.), matte, reflective, ruggedized, include a calibration pattern, and/or have any other appearance.

The base 122 can optionally include a display 160 that functions to display information. The display 160 can cover a part of the base 122, the full base 122, and/or any other portion of the base 122.

The displayed information on the display 160 can include user indicators, text (e.g., an advertisement, a user instruction, etc.), a calibration pattern (e.g., in a calibration mode), and/or any other displayed information. In a first example, the display 160 can display a graphic (e.g., outline, arrow, etc. surrounding the base of a physical item) that indicates identified and/or unidentified items, problematic items (e.g., stacked items, items that are preventing checkout, etc.), and/or other items. In a second example, the display 160 can display graphics that indicates where to place items, usage instructions, and/or provide other user guidance. In a third example, the display 160 can display an item indicator (e.g., for an identified item, a segmented item, etc.) adjacent the physical item.

The display 160 can be an interactive display, static display, and/or any other display.

However, the base 122 may be otherwise configured.

The set of supports 124 functions to support, mount, and/or otherwise position one or more sensors. The sampling system 100 preferably includes multiple supports 124, but can alternatively include a single support 124, and/or any other number of supports 124. In an example, the sampling system 100 can include 1, 2, 3, 4, and/or any other number of supports 124.

When the sampling system 100 includes multiple supports 124, the supports 124 can be pre-paired at the manufacturing site (e.g., using a unique support pair address), paired by the installer (e.g., wherein a support 124 broadcasts pairing credentials, and other supports 124 connect to the support 124 using the pairing credentials), wired together (e.g., by a wire installed by the installer, through power and/or data connections provided by the base 122, etc.), and/or otherwise connected together (e.g., paired).

The support 124 is preferably a post with an arm (e.g., a cantilevered post, a post with an overhang, a vertical post with a horizontal arm, a post with an unsupported extension, post with a lateral arm, etc.), but can additionally or alternatively include a straight post (e.g., a post without overhang, etc.), an arm, a frame (e.g., portal frame), overhanging support, overhead support, a wall, and/or have any other form factor. The support 124 can be straight (e.g., linear), curved (e.g., concave, convex, arcuate, bowed, etc.), angled (e.g., inward, outward, etc.), tapered (e.g., narrowing or widening along its length, etc.), stepped (e.g., discrete changes in cross-section, etc.), telescoping (e.g., extendable and/or retractable sections, etc.), articulated (e.g., hinged, jointed, etc.), adjustable (e.g., sliding track, lockable, etc.), collapsible, rigid, fixed, rotatable, detachable, cantilevered, and/or otherwise configured. When the sampling system 100 includes multiple supports 124, the supports 124 are preferably all have the same configuration, but can additionally and/or alternatively have different configurations.

The supports 124 are preferably static, but can alternatively be actuatable, and/or otherwise configured. The support(s) 124 can extend (e.g., upwards) from the base 122 (e.g., perpendicular to the base 122, at a non-zero angle to the base 122, etc.), extend from another support 124 (e.g., parallel the base 122, at an angle to the base 122, etc.), and/or be otherwise oriented relative to the base. When the support(s) 124 is a post with an arm, the post preferably extends from the support surface or base 112 and the arm extends cantilevered over a portion of the support surface or base 122. In a specific example, the support can be arranged offset from the base, wherein the arm extends over the support surface but not the base. In this specific example, the arm can include a first set of sensors (e.g., proximal the arm-post joint), an optional second set of sensors (e.g., on the free end of the arm, distal the arm-post joint, etc.), and/or any other number of sensors. The sensors on the arm can be directed toward (e.g., angled toward) the measurement volume and/or base, or otherwise configured. When the system includes multiple supports, the set of sensors (e.g., mounted to the arms) can collectively provide 1 field of view, 2 different fields of view (e.g., from opposing corners of the measurement volume, opposing sides of the measurement volume, etc.), 3 different fields of view, 4 different fields of view, and/or any other number of fields of view. Different fields of view can be separated by a predetermined distance (e.g., more than 50% of the base length, at least the base lateral length, at least the base longitudinal length, etc.), a predetermined angle (e.g., 30 degrees, 60 degrees, 90 degrees, 180 degrees, etc.), and/or be otherwise defined. When the system includes multiple supports with arms, the arms can extend in parallel, orthogonal to each other, or with any other relative pose. When the system includes multiple supports with arms, the posts can be arranged on the same or different side (e.g., longitudinal side, lateral side, etc.). Additionally and/or alternatively, the post and/or arm can be otherwise configured relative to the base 122.

The supports 124 are preferably arranged along a side (e.g., at or near an edge) of the measurement volume and/or base 122, but can additionally and/or alternatively be arranged at a corner (e.g., corner region) of the measurement volume and/or base 122, at a central region of the measurement volume and/or base 122, and/or otherwise positioned. The set of supports 124 is preferably arranged on the same side of the measurement volume and/or base 122, but can additionally and/or alternatively be arranged opposing each other across the measurement volume and/or base 122 (e.g., arranged on opposing regions of the base), on two different sides of the measurement volume and/or base 122, on two adjacent sides of the measurement volume and/or base 122, and/or be otherwise arranged.

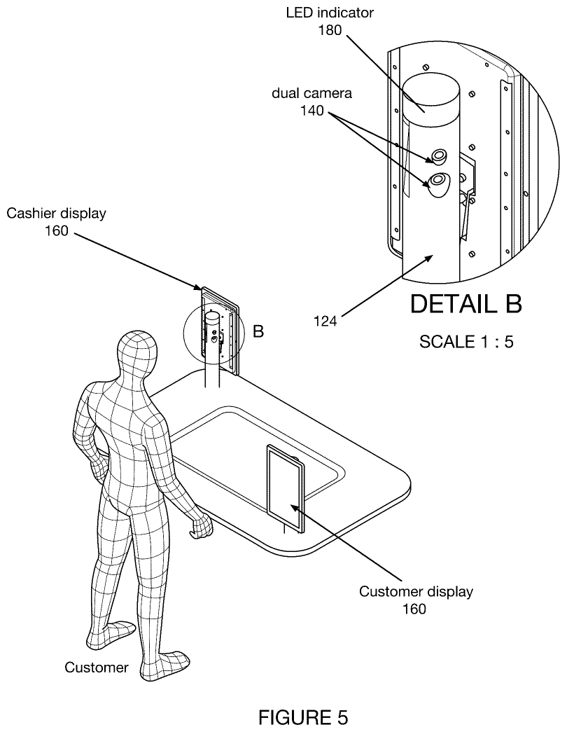

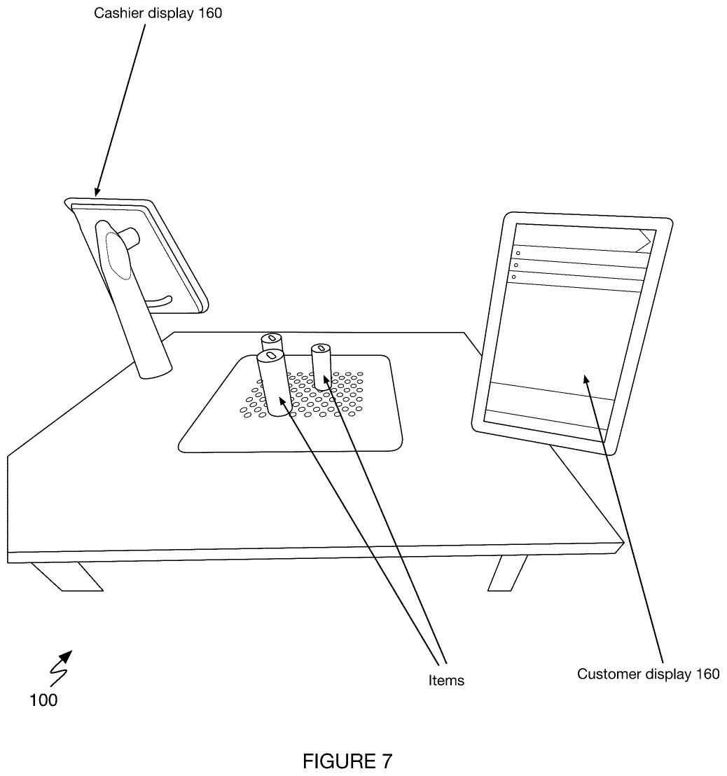

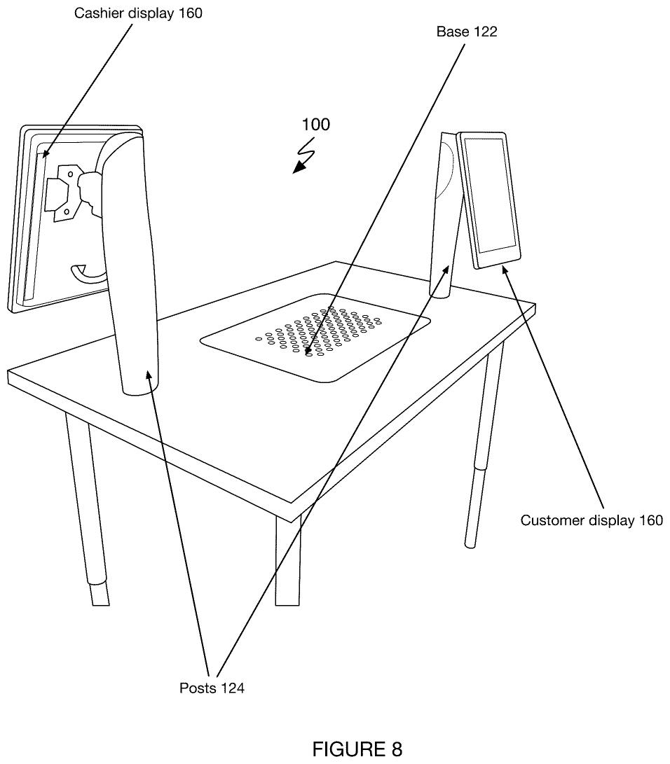

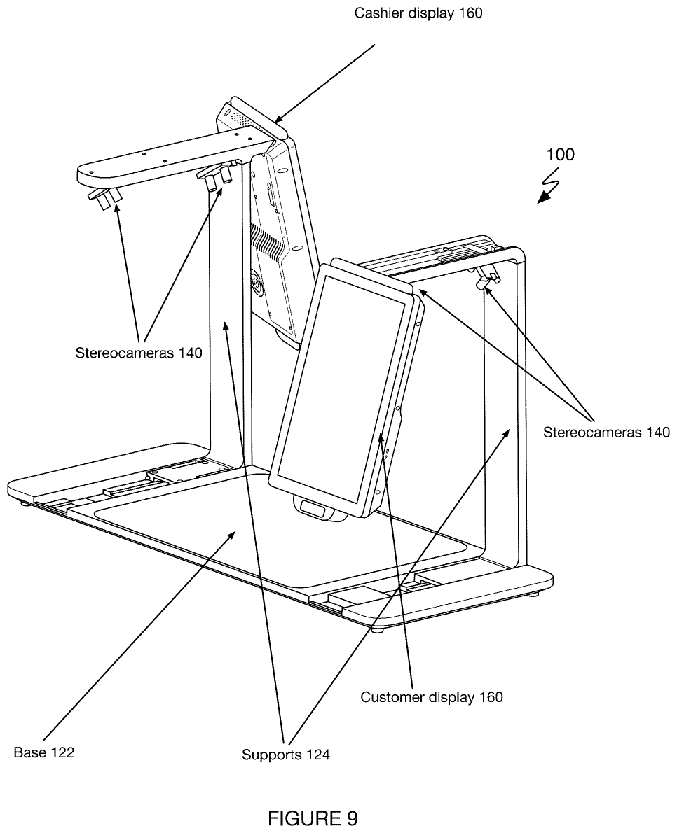

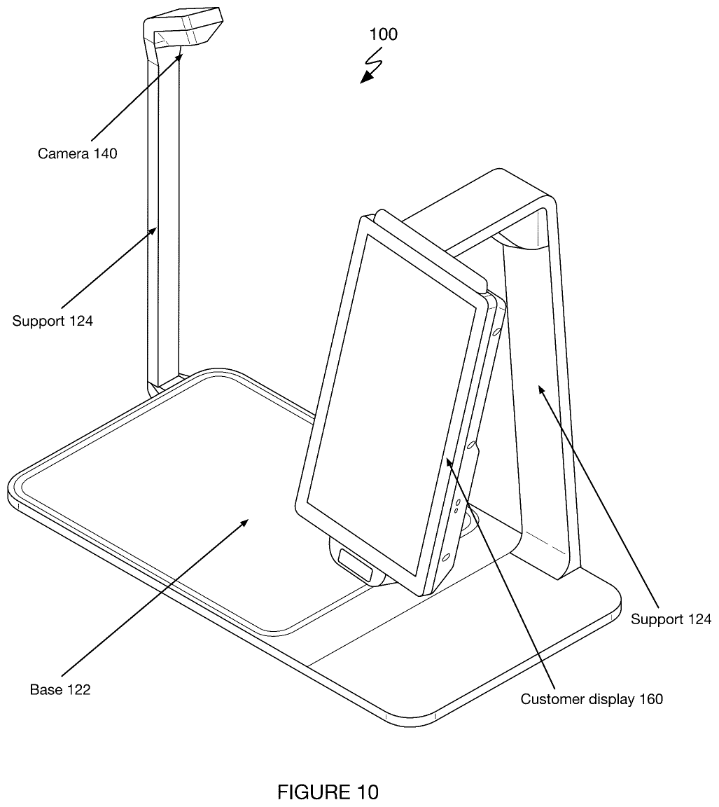

In an example, the supports 124 are preferably arranged on the same side of the measurement volume and/or base 122 (e.g., a first and second support 124 are arranged on the first and second corners of a shared side, etc.), but can additionally and/or alternatively be arranged at opposing corners of the measurement volume and/or base 122, on opposing sides of the measurement volume and/or base 122, on adjacent sides of the measurement volume and/or base 122, and/or otherwise arranged. The supports 124 can be mounted to the base corners, be mounted outside of the base corners (e.g., wherein the span between the supports 124 is longer than the diagonal span of the base 122; wherein the supports 124 are mounted to the supporting surface and not the base 122; etc.), be offset from the base corners (e.g., offset inwards, offset outwards, offset laterally, offset longitudinally, offset diagonally, etc.), and/or otherwise mounted. Examples are shown in FIG. 4, FIG. 5, FIG. 7, FIG. 8, FIG. 9, and FIG. 10. In a first specific example, the sampling system 100 includes a single support 124 mounted to the base 122 (e.g., does not include more than one support). In a second specific example, the sampling system 100 includes two supports 124 arranged on the same side of the base 122 (e.g., does not include more than two supports 124). In an illustrative example, the sampling system 100 can include a first support 124 at a back right corner and a second support 124 at a back left corner; example shown in FIG. 9. In another illustrative example, the sampling system 100 can include a first support 124 at a front right corner and a second support 124 at a front left corner. In a third specific example, the sampling system 100 includes two supports 124 arranged on two different adjacent sides of the base 122 (e.g., does not include more than two supports 124); example shown in FIG. 10. In a fourth specific example, the sampling system 100 includes two supports 124 arranged on opposing corners of the base 122 (e.g., does not include more than two supports 124); examples shown in FIG. 7 and FIG. 8. In an illustrative example, the sampling system 100 can include a first support 124 at a front right corner and a second support 124 at a back left corner. In another illustrative example, the sampling system 100 can include a first support 124 at a back right corner and a second support 124 at a front left corner.

However, the set of supports 124 may be otherwise configured.

However, the housing 120 may be otherwise configured.

The set of sensors 140 functions to sample measurements of the items (e.g., objects) within the measurement volume, monitor the measurement volume, and/or any other suitable functions.

The sampling system 100 preferably includes multiple sensors, but can alternatively include a single sensor, and/or any other sensors. The set of sensors 140 can include optical systems, weight sensors (e.g., arranged within the base), acoustic sensors, touch sensors, proximity sensors, vibration sensors, kinematic sensors (e.g., an IMU, gyroscope, etc.), and/or any other sensors.

The optical systems can include imaging systems, monocular cameras, stereo cameras, wide angle cameras, narrow field of view cameras, depth cameras, lidar, and/or any other optical systems. The cameras are preferably rolling shutter cameras, but can additionally or alternatively be global shutter cameras, and/or any other cameras. The optical system preferably functions to output one or more images of the measurement volume (e.g., image of items within the measurement volume), but can additionally or alternatively output 3D information (e.g., depth output, point cloud, etc.), and/or any other output.

In a first example, the optical system can include a depth sensor 140 (e.g., stereo camera, time of flight sensor, etc.) that measures geometric information (e.g., depth information) from the measurement volume, wherein the optical system can additionally include a color camera that captures the appearance (e.g., color) of items in the measurement volume.

In a second example, the optical system can include a monocular camera, wherein depth information is extracted from structure from motion, predicted using a neural network, depth from polarization, and/or other methods that extract depth from monocular cameras. In this example, the depth can be extracted from the image frame sampled by the monocular camera (e.g., depicting the appearance of the items, used to generate the appearance embeddings, etc.), or from another frame sampled by the monocular camera.

The imaging system preferably includes a 3D camera, but can alternatively a depth camera, 2D camera, and/or any other camera. In a first example, when the sampling system 100 includes a plurality of imaging systems (e.g., multiple cameras), the imaging systems can be 3D cameras. In a second example, when the sampling system 100 includes a single imaging system (e.g., a single camera), the imaging system can be a 2D camera. The imaging system can be: a stereo camera system (e.g., including a left and right stereo camera pair), a depth sensor (e.g., projected light sensor, structured light sensor, time of flight sensor, laser, etc.), a monocular camera (e.g., CCD, CMOS, etc.), a built-in camera from a device (e.g., tablet, smartphone, etc.), and/or any other imaging system.

In variants, the sampling system 100 can exclude (e.g., omit) a set of illumination elements that control the lighting within the measurement volume; alternatively, the sampling system 100 can include a set of illumination elements.

The sensors 140 can be mounted to the supports 124, base 122, and/or any other portion of the housing 120, but can additionally or alternatively be mounted to a display 160, a compute housing, and/or any other component. Each support 124 can include one or more sensors, or can alternatively not include any sensors. The sensors can protrude from the housing 120, be flush with the housing surface, be recessed into the housing, and/or be otherwise arranged relative to the housing.

In a first example, each support 124 includes a single camera 140 (e.g., stereo camera, monocular camera, etc.). In a first specific example, the system includes a single stereo camera pair mounted to each support. In a second specific example, the system includes a single monocular camera mounted to a single support.

In a second example, each support 124 includes two cameras 140 (e.g., two stereo cameras, two monocular cameras, etc.). The two cameras can be arranged laterally (e.g., to improve depth detection), vertically, and/or otherwise arranged. In a specific example, two stereo camera pairs can be mounted to each support.

When the sampling system 100 includes multiple supports 124, the supports 124 can have the same or different sets of sensors. In a first example, each support 124 includes the same set of cameras and kinematic sensors 140 (e.g., IMUs, etc.). In a second example, a first support 124 includes a monocular camera and kinematic sensors, while the second support 124 includes a stereo camera and kinematic sensors.

The sensors 140 are preferably static sensors (e.g., are not actuatable relative to the mounting surface), but can additionally or alternatively be mobile (e.g., tracking sensors, etc.). The sensors 140 are preferably mounted at the arm of the support 124, but can additionally or alternatively be mounted at the post of the support 124, the top of the support 124, partway along the height of the support 124 and/or at any other location. The sensors 140 are preferably mounted to the interior region of the support 124 (e.g., region proximal the measurement volume, region proximal the base 122, etc.), but can additionally or alternatively be mounted to the exterior surface of the support 124.

The sensor(s) are preferably positioned at a height of 18-24 inches above the base 122, but can alternatively be positioned less than 18 inches above the base 122, more than 24 inches above the base 122, at a position within a range inclusive and/or exclusive of the aforementioned values, and/or any other position. The sensor(s) can be positioned at a height lower than that of a user interface 160 (e.g., mounted to the support 124), positioned at a height greater than that of a user interface 160, at a height of a user interface 160, and/or any other height.

Different sensors 140 are preferably configured to have different fields of view, but can alternatively have the same fields of view, and/or any other configuration. The field of view is preferably fixed, but can alternatively be variable, adjustable, dynamic, and/or any other configuration. The field of view is preferably a slanted and/or angled view (e.g., camera captures both the top surface and some of the sides of the items), but can alternatively be a top-down view (e.g., camera captures straight down, with a field of view perpendicular to the base), be a profile and/or side view (e.g., camera captures horizontally at the items from the side), and/or any other view. When there are multiple sensors 140 with different fields of view, this configuration can mitigate occlusions of items (e.g., when there are multiple items placed on the base 122 and items occlude one another), but can incur any other suitable benefit and/or any other advantage.

The sensors 140 are preferably oriented toward the measurement volume, but can additionally or alternatively be oriented away from the measurement volume (e.g., outward, toward the front, toward the back, toward the user, etc.). The sensors 140 can be arranged with a field of view encompassing all or part of the measurement volume, with the optical axis intersecting the measurement volume, and/or be otherwise arranged. In an example, the sensors 140 mounted to the corners of the housing 120 (e.g., mounted to the supports 124) can be arranged with the respective fields of view encompassing: the opposing: lateral side (e.g., lateral edge), longitudinal side (e.g., longitudinal edge), corner, and/or other region of the housing 120.

The field of view of a single sensor 140 or combined fields of view of multiple sensors 140 preferably encompasses all of the base 122 (e.g., with items on the base 122, without items on the base 122, etc.), but can alternatively encompass a portion of the base 122, a region outside of the base 122, and/or any other regions. The sensors' fields of view (e.g., of the same or different sensor type) preferably collectively encompass the entirety of the measurement volume, but can additionally or alternatively encompass a portion of the measurement volume, define the measurement volume, and/or be otherwise related to the measurement volume.

The sensors fields of views preferably collectively define an optically enclosed space, but can alternatively define an optically open space. The measurement volume is preferably fully located within the optically enclosed space, but can additionally or alternatively overlap with the optically enclosed space (e.g., partially overlap, fully encompass the optically enclosed space, etc.), be partially encompassed by the optically enclosed space, and/or be otherwise related to the optically enclosed space. In a first example, the measurement volume is optically enclosed, such that every point within the measurement volume lies within the collective viewing frustum of all optical sensors 140 of the sampling system 100 (e.g., no point is outside the optical coverage). In a second example, the measurement volume extends partway up the support height (e.g., 50%, 60%, 70%, 80%, 90%, etc.) and has substantially the same footprint as the base 122 (e.g., has a footprint that is more than 80% or 90% of the base footprint), wherein the optically enclosed space encompasses the entirety of the measurement volume. In a third example, the measurement volume extends beyond the support height (e.g., 50%, 60%, 70%, 80%, 90%, etc.) and has substantially the same footprint as the base 122 (e.g., has a footprint that is more than 80% or 90% of the base footprint), wherein the optically enclosed space encompasses the entirety of the measurement volume.

The set of sensors 140 preferably collectively sample two or more views of an item, but can additionally or alternatively sample a single view of the item. The set of sensors 140 can sample a single frame of the item, a time series of frames of the item (e.g., a video), and/or any other number of frames of the item. The sensor(s) can be oriented at a pitch of approximately 30 degrees relative to horizontal, at a pitch less than 10 degrees relative to horizontal, at a pitch of 10-30 degrees relative to horizontal, at a pitch of 30-50 degrees relative to horizontal (e.g., 30 degrees upward), at a pitch greater than 50 degrees relative to horizontal, within a range inclusive and/or exclusive of the aforementioned values, and/or any other pitch orientation. The sensor(s) can be oriented at a roll of approximately 20 degrees relative to horizontal, at a roll of less than 20 degrees relative to horizontal, at a roll 20-40 degrees relative to horizontal, at a roll greater than 40 degrees relative to horizontal, within a range inclusive and/or exclusive of the aforementioned values, and/or any other orientation.

In a first variant, the sensor 140 from the set of sensors 140 can be arranged such that the respective field of view encompasses a proximal side of a base 122 and at least a portion of an opposing side of the base 122, wherein a set of items located on the opposing side can be fully or partially (e.g., at least 50%, 60%, 70%, 80%, 90%, etc.) within the field of view.

In a second variant, the sensor 140 of the set of sensors 140 is arranged such that items (e.g., taller items such as tall beverage cans) positioned at each corner of the base 122 are fully or partially (e.g., at least 50%, 60%, 70%, 80%, 90%, etc.) within the field of view.

In variants, the sampling system 100 can optionally include a set of guard sensors 140 that function to wake the sampling system 100 from a low-power mode to a fully-operational mode. The guard sensors 140 can enable conservation of power of the imaging system and/or non-guard cameras, reduce unnecessary data generation and network bandwidth usage, and/or provide any other suitable benefit. The guard sensors 140 can be: a camera of the sensor set, a separate sensor (e.g., light sensor, proximity sensor, vibration sensor, etc.), and/or any other sensor. In an example, when the sampling system 100 includes multiple cameras (e.g., multiple stereo camera pairs, multiple monocular cameras, etc.), one of the cameras can function as a guard camera (e.g., powered on continuously to monitor for motion) and the remaining cameras can function as non-guard cameras (e.g., inactive and/or powered off until triggered). Alternatively, all cameras can be guard cameras, all cameras can be non-guard cameras, the sampling system 100 can include an additional low-power sensor, and/or any other set of guard sensors. In an example, when the guard sensor detects a trigger event (e.g., upon detection of motion, ambient light increase, etc.), the guard camera transmits a signal to turn on the processing system 180 and the non-guard cameras.

However, the set of sensors 140 may be otherwise configured.

The system can optionally include a set of user interfaces 160, which functions to provide information to and/or receive information from a user.

The user interface 160 can include one or more displays 160, audio outputs (e.g., a set of speakers), tactile systems, capacitive touch systems (e.g., a touchscreen), acoustic sensors (e.g., microphone), cameras (e.g., front-facing camera), lighting elements, and/or any other user interface components.

The lighting elements can function to visually indicate a sampling system status. The lighting elements are preferably LED, but can alternatively be OLED, laser diodes, and/or any other lighting element type. The lighting elements are preferably colored lights (e.g., single-color, RGB multicolor, etc.), but can alternatively be non-colored lights, and/or any other lighting element configuration. When the lighting elements are colored lights, different colors can be associated with different machine statuses (e.g., machine is free, machine is busy, etc.), and/or any other color-status association. In examples, the lighting elements can indicate sampling system state (e.g., in use, awake, asleep, etc.), whether an error has occurred, and/or whether a successful transaction has been completed. The lighting element(s) can be operably coupled (e.g., mounted on, embedded in, etc.) to a support, to the base 122 (e.g., lighting elements arranged around the perimeter of the base), to a display 160, and/or to any other housing component.

In examples, the user interface 160 can be a tablet, smartphone, and/or other user device. In variants, the sensors 140 on the user interface 160 can be excluded from the set of sampling system sensors. Alternatively, the user interface sensors can be included in the set of sampling system sensors.

The sampling system 100 preferably includes multiple user interfaces 160, but can alternatively include a single user interface 160, and/or any other user interfaces. The user interfaces 160 can be used by customers, cashiers, and/or any other user. In an example, the multiple user interfaces 160 can be used by: two different customers (e.g., wherein customers can place items into the measurement volume and self-check out from both sides of the sampling system 100); by a cashier and a customer (e.g., on opposing sides of the sampling system 100); and/or any other set of users. In an example, the sampling system 100 can include multiple user interfaces 160 (e.g., for assisted self-checkout). In a specific example, the sampling system 100 can include a user interface 160 mounted to each support 124 (e.g., one mounted to the right support, another mounted to the left support). In an example, the sampling system 100 can include a single user interface 160 (e.g., for self-checkout).

The user interface 160 is preferably mounted to a support 124 of the set of supports 124, but can additionally or alternatively be mounted to a base 122, be separate from the housing 120, and/or be otherwise arranged. The user interface 160 can be mounted at the arm of the support 124 (e.g., to the end of an arm, side of an arm, etc.), at the post of the support 124, the top of the support 124, partway along the height of the support 124, and/or any other suitable location. The user interface 160 can be mounted to the interior surface of the support 124 (e.g., region proximal the measurement volume, region proximal the base 122, etc.), to an exterior surface of the support 124, and/or to any other surface of the support. When the sampling system 100 includes multiple user interfaces 160 (e.g., a cashier display and a customer display), the multiple user interfaces 160 preferably are mounted to an interior surface of a first support 124 and an exterior surface of a second support, but can additionally and/or alternatively be mounted to any other suitable location; example shown in FIG. 9. When the sampling system 100 includes a single user interface 160 (e.g., a customer display), the single user interface 150 preferably is mounted to an interior surface of a support 124, but can additionally and/or alternatively be mounted to any other suitable location; example shown in FIG. 10.

In an example, the sampling system 100 can include a display 160 integrated into the base 122. The base display 160 can display a calibration pattern when a sensor calibration is needed, display user instructions when a user is interacting with the measurement volume, display item identifiers (e.g., item name, prices, a green boundary surrounding the item footprint, etc.) when items have been identified by the system, display advertisements or other media when in an idle mode, and/or otherwise display any other content or information.

The user interface 160 is preferably mounted partway up the height of the housing 120, but can additionally or alternatively be mounted at the bottom of the housing 120, top of the housing 120, and/or to any other region of the housing 120. In an example, the user interface 160 can be mounted partway up the height of the measurement volume.

The user device can be statically mounted or movably mounted. The set of user interfaces 160 can include user devices that can be tilted (e.g., toward a user, away from a user, etc.), rotated (e.g., around a vertical axis, around a horizontal axis, etc.), swiveled (e.g., pivot side-to-side), retractable (e.g., pulled back into a housing 120 or base), raised and/or lowered (e.g., vertical movement), pivotable (e.g., rotation around a mount point), flippable (e.g., rotated 180 degrees, front to back, etc.), and/or otherwise positioned.

The user interface 160 can include an onboard processing system 180 (e.g., processors, memory, etc.), or can be driven by a separate compute housing (e.g., of a processing system), and/or any other system.

However, the set of user interfaces 160 may be otherwise configured.

The set of processing systems 180 functions to process a set of measurements to identify each of a set of items within the measurement volume. The set of processing systems 180 can preferably include one processing system 180, but can alternatively include multiple processing systems 180, and/or any other number of processing systems 180.

The set of processing systems 180 can be: local to the sampling system 100, remote (e.g., a remote computing system), distributed between the local and remote system, distributed between multiple local systems, distributed between multiple sampling systems 100, and/or any other otherwise arranged relative to the sampling system 100.

The processing system 180 can include one or more processors (e.g., CPU, The set of processing systems 180 can include GPU, TPU, microprocessors, ASICs, FPGAs, etc.), and/or any other processing systems. The processing system 180 can optionally include memory (e.g., RAM, flash memory, long-term data storage, HDD, SSD, flash, etc.), other nonvolatile computer medium configured to store instructions for method execution, repositories, and/or other data. The processing system 180 can optionally include input and/or output interfaces (e.g., USB, Ethernet, HDMI, PCIe, wireless transceivers, for connecting peripherals, sensors, and/or networks, etc.), and/or any other interfaces. In variants, the wireless transceivers can be used to connect to a network (e.g., local Wi-Fi network, local sampling system network, etc.), wherein the processing system 180 can receive and/or communicate updates (e.g., model updates, item repository updates, etc.) to and/or from other sampling systems and/or a central platform via the network.

In a first variant, the processing system 180 can be the processing system 180 of the user interface 160.

In a second variant, the processing system 180 can be separate from the processing system of the user interface 160. In this variant, the processing system 180 can be arranged in: the support, the base 122, a separate computing system (e.g., connected to the components in the housing 120 by a wired or wireless connection), and/or otherwise arranged relative to the other sampling system components.

However, the set of processing systems 180 may be otherwise configured.

The system can optionally include a set of communication modules, which functions to transfer information between the sampling system 100 and an endpoint (e.g., another sampling system 100, a remote computing system, the user interface 160, etc.).

The information transferred between the sampling system 100 and a remote computing system can include a repository update, new transaction information, and/or any other information. The repository update can be from the sampling system 100, from a plurality of sampling systems 100 connected by a network, and/or any other repository update. The repository updates can include updated item identifiers, updated item transaction information (e.g., pricing, etc.), updated item embeddings, and/or any other repository updates.

The communication module is preferably a wireless communication module, but can alternatively be a wired communication module, and/or any other communication module. The set of communication modules can include long-range communication module (e.g., supporting long-range wireless protocols), short-range communication module (e.g., supporting short-range wireless protocols), and/or any other modules. In examples, the communication modules can include cellular radios (e.g., broadband cellular network radios), such as radios operable to communicate using 3G, 4G, and/or 5G technology, Wi-Fi radios, Bluetooth (e.g., BTLE) radios, NFC modules (e.g., active NFC, passive NFC), Zigbee radios, Z-wave radios, thread radios, wired communication modules (e.g., wired interfaces such as USB interfaces), and/or any other communication modules.

The communication modules are preferably mounted within the housing 120, but can additionally or alternatively be separate from the housing 120. In examples, the communication modules are located within the supports, in the base 122, be the user interface's communication modules, and/or any other locations.

However, the set of communication modules may be otherwise configured.

However, the sampling system 100 may be otherwise configured.

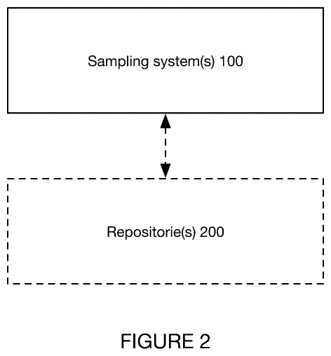

The system can optionally include a set of repositories 200, which functions to store information related to an item, a transaction, and/or any other suitable information. The set of repositories 200 can be used by one or more sampling systems 100. An example is shown in FIG. 2. The set of repositories 200 can include item repositories, transaction repositories, and/or any other repositories. The set of repositories 200 can store item information such as: item identifiers (e.g., user-readable identifiers, SKU information, etc.); item embeddings; classification information (e.g., patterns, vectors, etc.); pricing; stock; item purchase history (e.g., instances of an item purchased, frequency of an item purchased); and/or any other information.

The item embeddings can be for one or more modalities. Different modalities are preferably embedded into different latent spaces (e.g., appearance is embedded into an appearance space, geometry is embedded into a geometric space, etc.), but can alternatively be embedded into the same latent space (e.g., both appearance and geometry are embedded into the same space), be embedded into different latent spaces then combined downstream (e.g., by a secondary encoder), and/or otherwise managed. In examples, the item embeddings can include appearance embeddings (e.g., embedding the color and/or visual appearance of an item, embedding the 2D appearance of an item, embedding an image of the item, etc.); geometry embeddings (e.g., embedding the geometry, shape, extent, size, and/or other geometric parameter of an item, etc.); text embeddings (e.g., embedding any text detected on the item; embedding of a text description of the item; etc.); thermal embeddings (e.g., embedding of the thermal profile of the item, etc.); and/or any other set of embeddings in any other modality.

The embeddings are preferably determined by trained encoders, but can additionally or alternatively be determined by the encoding layers of a larger neural network (e.g., of a CNN, classification model, object detection model, transformer, etc.), and/or otherwise determined. Different modalities can use different encoders, trained in different ways (e.g., the appearance or image encoder can be from a CNN, while the geometry encoder is from a transformer, etc.).

The embeddings can be determined from the same or different raw information. In an example, the appearance embeddings are determined from 2D color images, while the geometry embeddings are determined from depth information (e.g., directly sampled or extracted from the 2D color images).

The embeddings preferably do not have semantic human meaning on their own, but can alternatively have semantic meaning. The item embeddings are preferably for a single item (e.g., wherein the item is segmented before embedding), but can alternatively be for the set of items and/or for any other items. The repository 200 preferably stores item embeddings for known items, but can alternatively store item embeddings for unknown items. In a first example, the repository 200 can store a reference embedding or cluster of embeddings associated with a known item identifier. In a second example, the repository 200 can store clusters of embeddings associated with unknown item identifiers.

The known item embeddings stored in the repository 200 can be matched against known embeddings for known items (e.g., wherein items are identified using a proximity metric, such as a cosine distance), used to predict an item identifier (e.g., fed into a decoder or a classification head), and/or otherwise used.

The item embeddings (and/or other information) can be added to the repository 200 during or after: each usage session (e.g., each transaction), when an addition request is received (e.g., the system identifies that the item is an unknown item and/or associated with a new or unnamed cluster, and prompts the user to enter an item identifier for the item), and/or at any other time.

The set of repositories 200 can store transaction information such as: items purchased (e.g., identifiers thereof); quantity of each item; price per item; whether or not the item was identified; payment information (e.g., transaction number, hash of the credit card, etc.); probability or confidence of item identification; transaction time (e.g., transaction timestamp, transaction date, etc.); and/or any other information.

One or more repositories of the set of repositories 200 can be populated and/or maintained by a merchant, a central entity, and/or any other entity. In an example, the repositories 200 are shared across a fleet of sampling systems 100. In this example, a source set of repositories 200 can be maintained by a master system (e.g., central system, cloud computing system, one of the set of sampling systems 100, etc.), which updates the repositories 200 stored on the follower systems. Alternatively, the set of repositories 200 can be stored in a distributed storage system (e.g., spread across the sampling systems 100 in the fleet).

However, the set of repositories 200 may be otherwise configured.

The system can optionally include a set of point of sale (POS) systems, which functions to receive, encrypt, confirm, and/or otherwise process payment for the transaction (e.g., invoice).

The POS system can include a card reader (e.g., credit card reader, debit card reader, gift card reader, etc.), a cash register (e.g., manual cash register, automated cash register configured to calculate and return change, etc.), a barcode reader (e.g., camera, QR code reader, etc.), a NFC reader, a IC chip reader, and/or any other component.

The payment forms accepted by the POS system can include cash, credit card, debit card, store credit, cryptocurrency, and/or any other payment form.

The POS system can be communicatively connected to the system (e.g., wirelessly connected, connected by a wire, connected to the processing system 180, etc.), and/or otherwise connected. The POS system can be integrated into the sampling system 100 or be separate from the sampling system 100. In a first example, the POS system can be integrated into the user interface 160. In a second example, the POS system can be mounted to a support. In a third example, the POS system can be a separate unit connected to the sampling system 100 (e.g., via a wired or wireless connection), wherein the sampling system 100 passes item information (e.g., item identifiers, transaction information, etc.) to the POS system.

Each sampling system 100 is preferably paired with a single POS system, but can additionally or alternatively be paired with multiple POS systems. Each POS system is preferably paired with a single sampling system 100, but can additionally or alternatively be paired with multiple sampling systems 100.

However, the set of point of sale (POS) systems may be otherwise configured.

The system can optionally include a set of models, which functions to process the measurements, identify items, and/or perform any other suitable functionalities.

In examples, the set of models can segment the measurements into item segments, embed the item segments into embeddings (e.g., in one or more modalities), identify the items based on the embeddings, determine transaction information for the identified items, and/or otherwise be configured.

The system can include one or more models (e.g., for different functionalities, different modalities, etc.), and/or any other models.

The models can be or include a neural network (e.g., CNN, DNN, etc.), an equation (e.g., weighted equations), regression, classification (e.g., semantic segmentation models, instance-based segmentation models, etc.), rules, heuristics, foundation model, transformer, encoder, and/or any other architecture. The models can be trained on manually-labeled data, synthetic data, and/or any other data.

In an example, the set of models can use the same segmentation and encoding model for all items, and request item information (e.g., SKU, item identifier, price, etc.) when the extracted item representation (e.g., item embedding(s)) do not appear in the repository 200.

The models can be trained using supervised learning, unsupervised learning, semi-supervised learning, single-shot learning, zero-shot learning, and/or any other learning approach.

However, the set of models may be otherwise configured.

In variants, the system can use the systems and/or methods disclosed in U.S. application Ser. No. 19/207,168 filed 13-MAY-2025, U.S. application Ser. No. 15/497,730 filed 26-APR-2017, U.S. application Ser. No. 18/526,629 filed 01-DEC-2023, U.S. application Ser. No. 16/180,838 filed 30-APR-2019, U.S. application Ser. No. 16/104,087 filed 30-APR-2019, U.S. application Ser. No. 18/617,183 filed 26-MAR-2024, U.S. application Ser. No. 17/079,056 filed 23-OCT-2020, U.S. application Ser. No. 19/229,363 filed 05-JUN-2025, U.S. application Ser. No. 17/945,912 filed 15-SEP-2022, each of which are incorporated herein in their entireties by this reference.

However, the system can be otherwise configured.

### 3. METHOD

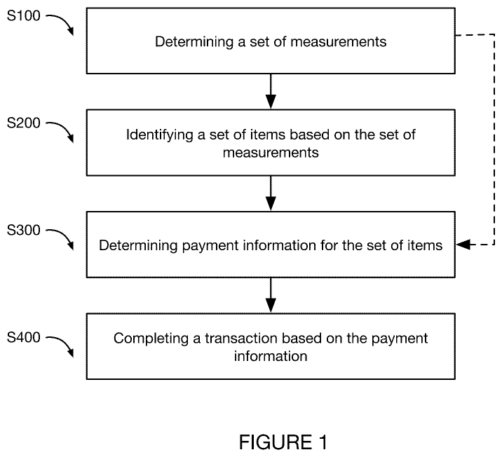

In variants, the method can include: determining a set of measurements S100; identifying a set of items based on the set of measurements S200; determining payment information for the set of items S300; and completing a transaction based on the payment information S400. The method functions to identify a set of items within a measurement volume based on a set of measurements. An example is shown in FIG. 1.

All or portions of the method can be performed in real-or near-real time (e.g., less than 100 milliseconds, less than 1 second, within 1 second, within 5 seconds, etc.), iteratively performed, be performed asynchronously or with any other suitable frequency, and/or otherwise performed. All or portions of the method can be performed automatically, manually, and/or otherwise performed. All elements or a subset of elements of the method are preferably performed by the system, but can additionally and/or alternatively be otherwise performed. The method is preferably performed by the sampling system 100 discussed above, but can additionally or alternatively be performed by any other sampling system 100.

Determining a set of measurements S100 functions to determine measurements of the measurement volume for item recognition. S100 is preferably performed before S200, but can alternatively be performed concurrently with S200, before S300, concurrently with S300, after S300, and/or otherwise timed. S100 is preferably performed after one or more items are detected within a measurement volume, but can alternatively be performed after a checkout session (e.g., transaction) is initiated, and/or otherwise performed at any other suitable time. Items can be detected within the measurement volume when the base 122 or base pattern is occluded, when a motion sensor detects motion within the measurement volume, when a weight sensor connected to the base 122 is triggered (e.g., the measured weight increases), when an item breaks a light beam or sheet extending across a measurement volume opening, and/or any other suitable condition is met. A transaction can be initiated when an item is detected within the measurement volume, a user manually indicates transaction initiation (e.g., by selecting a button), a user is detected in front of the system, and/or any other suitable condition is met.

The set of items is preferably statically positioned (e.g., within the measurement volume, relative to the ambient environment, globally static, etc.), but can alternatively be mobile, and/or be otherwise positioned.

S100 is preferably performed automatically, but can alternatively be performed manually, and/or otherwise performed. S100 is preferably performed by a single sampling system 100, but can alternatively be performed by multiple sampling systems 100, a remote system (e.g., drone, satellite, etc.). In an example, S100 can be performed by the sensors 140 on the sampling system 100. In a specific example, the set of sensors 140 can include multiple stereo camera pairs (e.g., two stereo camera pairs, three stereo camera pairs, four stereo camera pairs, etc.), a single stereo camera pair, a single monocular camera, and/or any other sensors.

Different sensors 140 of the set of sensors 140 preferably sample (e.g., take images of) the measurement volume contemporaneously or concurrently, but can alternatively sample the measurement volume sequentially, in parallel, in a predetermined order, and/or otherwise sample the measurement volume. The measurements can be captured, acquired, sampled, retrieved, received, and/or otherwise obtained. The measurements are preferably captured while the measurement volume and/or portions of the measurement volume (e.g., base) are static (e.g., not moving relative to ambient environment), but can alternatively be captured while measurement volume and/or portions thereof are in motion, and/or otherwise captured.

The measurements for the items concurrently within the measurement volume are preferably concurrently sampled (e.g., sampled at the same time), but can alternatively be serially sampled (e.g., while the items are being moved into and/or out of the measurement volume), and/or otherwise sampled. The measurements can be associated with a set of timesteps (e.g., timestamp, time window, time interval, time period, etc.), but can alternatively be associated with a single timestep, and/or any other timestep configuration.

The measurements used to identify the item(s) can be associated with a same time (e.g., timestamp, time window, time interval, time period, etc.) or different times. In a first example, multiple measurements (e.g., of the same or different modality) can be sampled contemporaneously (e.g., concurrently, within a predetermined sampling timestep, etc.). In a second example, multiple sensors 140 capture multiple measurements at the same time. In a third example, a single sensor 140 can capture a timeseries of measurements.

The measurement can record a parameter of the measurement volume, a parameter of one or more items, a parameter of a user, and/or any other parameter. The parameter of the measurement volume can include visual appearance (e.g., wherein the measurement depicts the item, wherein the measurement depicts the measurement volume, etc.), a geometry (e.g., depth), a chemical composition, a thermal distribution, audio, video, and/or any other parameter.

The set of measurements can be: 2D, 3D, and/or any other dimensional measurement. The measurements can include images (e.g., 2D images, 3D images, etc.), point clouds (e.g., generated from LIDAR, RADAR, etc.), depth maps, height maps, depth images, audio, video, and/or any other measurement.

In examples of images that can be used include: images captured in color (e.g., RGB, hyperspectral, multispectral etc.), black and white, grayscale, IR, NIR, UV, and/or captured using any other suitable wavelength; images with depth values associated with one or more pixels (e.g., such as that generated from a stereo camera pair); and/or any other images.

The measurements are preferably exterior measurements of items, but can alternatively include interior measurements of items, and/or any other measurements. The measurements are preferably angled measurements of the measurement volume (e.g., angled downward, angled upward, etc.), but can alternatively be top-down measurements, side measurements, and/or sampled from any other suitable pose or angle relative to the measurement volume and/or item. The measurements can be a full-frame measurement, a segment of a measurement (e.g., segment depicting the item), a merged measurement (e.g., a mosaic of multiple measurements), and/or any other measurement.

Each instance of S100 can include sampling one or more measurements with each sensor 140 (e.g., camera, camera pair, etc.). When multiple measurements are sampled by a sensor, the multiple measurements can be averaged, reduced to a single measurement (e.g., the image with the highest resolution is selected from a plurality of images), and/or otherwise processed.

In examples, a measurement can depict: the set of items in the measurement volume, the calibration pattern, an edge of the base 122, a known fiducial, a user (e.g., a user's hand), and/or any other suitable subject. The set of measurements preferably collectively captures a plurality of views of the measurement volume, but can alternatively capture a single view of the measurement volume, and/or otherwise capture views of the measurement volume. The set of measurements are preferably aligned and/or registered with a common coordinate system, and/or otherwise processed, but can additionally and/or alternatively be otherwise configured.

The set of measurements preferably includes two or more measurements, but can alternatively include one measurement, less than two measurements, a number of measurements within a range inclusive and/or exclusive of the aforementioned values, and/or any other number of measurements.

In a first example, S100 can include sampling a first and a second color image (e.g., 2D) from opposing viewpoints by a first and second sensor system 140 (e.g., mounted to a first and second support, respectively) mounted at opposing corners of the measurement volume. In this example, depth and/or geometry information can be extracted from the first and second color image (e.g., using stereo triangulation, feature-based triangulation, structure from motion, multi-view stereo, optical flow, photometric methods, visual hulls, a neural network, etc.).

In a second example, S100 can include sampling a geometric measurement (e.g., point cloud, depth map, etc.) and a 2D color image with a sensor set 140 (e.g., wherein the geometric sensor and the color camera can be mounted to the same or different support).

In a third example, S100 can include sampling a stereo image (e.g., two color images) with a stereo camera (e.g., two monocular cameras separated by a known baseline), wherein one or both color images can be used to extract appearance features, and both color images can be used to extract a geometry (e.g., using stereo methods, a neural network, etc.), then used to extract geometric features.

However, determining a set of measurements S100 may be otherwise performed.

Identifying a set of items based on the set of measurements S200 functions to determine the identity of the items within the measurement volume (e.g., which items are to be checked out), such that each item can be included in the transaction. S200 is preferably performed after S100 and before S300, but can alternatively be performed concurrently with S100, concurrently with S300, after S300, before S400, and/or otherwise timed.

The items can be identified based on one or more of: the appearance of each item depicted within the measurement (e.g., visual appearance within the visual data), the geometry of each item captured within the measurement (e.g., depth information, height map, etc.) of each item, weight information of each item (e.g., captured as it is placed into the measurement volume), temperature information for each item, a semantic identifier detected within the measurement (or without use of a semantic identifier), a set of item tracks (e.g., over time), and/or any other identification method.

S200 is preferably performed automatically (e.g., using a model), but can alternatively be performed manually, and/or otherwise performed. S200 can be performed at a predetermined frequency, responsive to detection of new items within the measurement volume, responsive to motion detection within the measurement volume, responsive to receipt of a user input (e.g., an identify items instruction), responsive to any other suitable event, after completion of a prior transition, while a checkout confirmation is not received, and/or otherwise performed. In an example, S200 can be performed each time a new set of items (e.g., a new batch of items) is inserted into the measurement volume. In an example, S200 can be performed each time a button (e.g., on a system or POS system) is selected by a cashier on a cashier display 160 and/or a customer on a customer display 160.

S200 is preferably performed at least once for each set of items, but can alternatively be performed multiple times for each set of items, and/or any number of times. The set of items preferably includes a batch of items (e.g., one or more items), but can alternatively be multiple batches of items, a single item, and/or any other items. A batch of items preferably includes all items located within a measurement volume at a given time (e.g., items concurrently located within the measurement volume), and/or any other items.

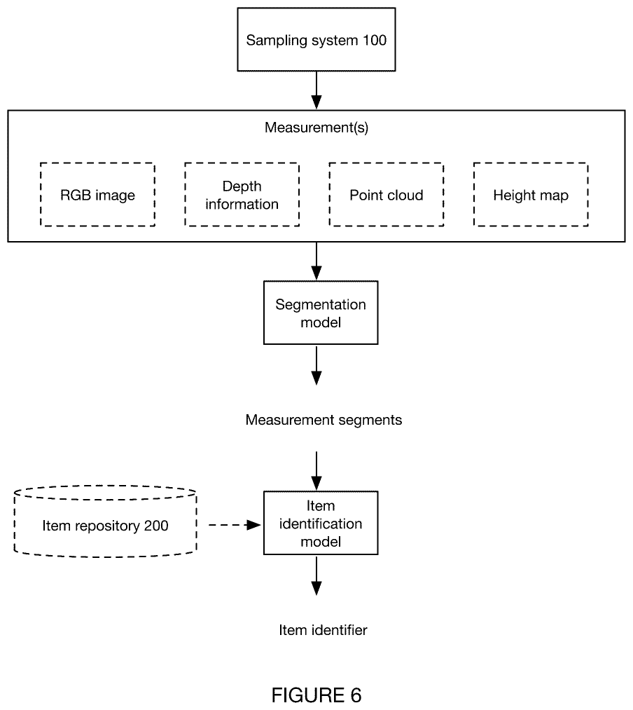

In variants, S200 can include: segmenting the measurements into a set of item segments, extracting an item representation for each item based on the respective item segments, and identifying each item based on the respective item representation. An example is shown in FIG 6.

Each segment preferably represents a single item, but can alternatively represent multiple items. The segments are preferably determined in every measurement modality (e.g., in 2D imagery, geometric measurements, etc.), but can additionally or alternatively be determined in a single modality. The segments can be determined in a single modality, then projected into a second modality (e.g., wherein different modality measurements are co-registered or otherwise aligned); alternatively, the segments can be independently determined in each modality, and/or otherwise determined. In examples, the measurement modalities can be co-registered using the 3D measurements, using the calibrations, and/or otherwise registered. In an example, the stereo point clouds generated from the 3D cameras to establish a correspondence between identical items captured from different viewing angles. When the segments from the first modality are projected into the second modality, the segments can be treated as or converted into region masks (e.g., 2D masks, 3D masks, etc.) before segmenting the second modality.

In a first variant, the segments are determined in the geometric space (e.g., using the geometric measurement), wherein the geometric segment is projected into the 2D image space. In a first example, the geometric segment can be determined by identifying a geometric feature (e.g., a narrowing, a constriction, a neck, a minima, etc.) and segmenting along the geometric feature (e.g., using a planar cut extending from the top down, from the side, etc.). In a second example, the geometric segments are predicted using a trained segmentation model (e.g., neural network); example shown in FIG. 6.

In a second variant, the segments are determined in the image space (e.g., using an image segmentation model), then projected into the geometric measurement.

The item representation can be an embedding, a set of features (e.g., human-readable features, handcrafted features, etc.), and/or any other representation. The item representation is preferably extracted using an encoder, but can be otherwise extracted. A different item representation can be extracted for: each modality (e.g., a first representation for appearance or 2D imagery; a second representation for geometry; etc.), each frame, a combination of modalities (e.g., a representation represents both appearance and geometry), a combination of frames (e.g., a representation represents from multiple frames), and/or any other set of measurements.

In an example, the set of item representations can include an appearance embedding, a geometry embedding, a text embedding, and/or any other embedding. In another example, the set of item representations can include a hybrid embedding that represents multiple modalities, wherein the hybrid embedding can be: directly predicted from the raw measurements, predicted from per-modality embeddings, and/or otherwise determined. The item embeddings from different modalities can be associated with the same item through the modality registration and/or otherwise determined.

The item can be identified by: retrieving the item identifier for a similar known item embedding(s) (e.g., wherein the extracted item embedding(s) and the known item embedding(s) are within a threshold distance of each other), predicting an item identifier based on the item representation (e.g., using a classification head), receiving an item identifier from a user (e.g., cashier, customer, etc.), and/or using any other identification approach.

In variants, a modality's embedding can be used to disambiguate between potential item representation matches. In an example, the geometric embedding for a soda can (e.g., embedding the size of the soda can) can be used to disambiguate between two different item embedding clusters that have similar appearance.

In variants, a modality's embedding can be used to determine errors. In an example of the variants, a geometric embedding can be used to determine that items have been stacked (e.g., when the geometric embedding does not match any known items'geometric embeddings), which can trigger a user notification to unstack the items, trigger an additional segmentation (e.g., a side-perspective segmentation, using a horizontal cut, etc.), and/or trigger other mitigation actions.

The method can optionally include determining a set of item indicators for the set of items, which functions to display the item identifiers on the user interface 160 (e.g., display on the base 122, a listing of the items, etc.). The item indicators can include an outline of an item, a bounding box of an item, an arrow pointing to an item, and/or any other item indicator. The set of items can be unidentified items, identified items associated with an uncertainty lower than a predetermined threshold (e.g., low confidence score), identified items associated with a certainty higher than a threshold, identified items associated with an advertisement (e.g., BOGO item), other identified items, and/or any other items.

The item indicators are preferably displayed on a display 160 on base 122, on a customer display 160, cashier display 160, and/or any other display 160. In an example, a user (e.g., customer, cashier, etc.) is prompted by the item indicator of an item displayed on the base 122 perform an action (e.g., move item, grab another item, etc.), wherein the sensors 140 can capture updated measurements. Multiple item indicators can be displayed concurrently, serially, and/or otherwise displayed. The item indicators can be displayed for a batch of items, for a single item, for multiple items, and/or any other suitable display context. The item indicators are preferably determined automatically, but can alternatively be determined manually, and/or otherwise determined.

In a first variant, determining a set of item indicators for the set of items can include determining a bounding box and/or an outline of an item by segmentation and displaying the bounding box and/or outline of the item on a display 160 (e.g., on the base 122, outlining the physical item).

In a second variant, determining a set of item indicators for the set of items can include determining a bounding box and/or an outline of an item by segmentation, determining a geometric centroid of the bounding box and/or the outline, displaying an item indicator (e.g., arrow pointing to the centroid) on a display 160.

However, determining a set of item indicators for the set of items may be otherwise performed.

However, identifying a set of items based on the set of measurements S200 may be otherwise performed.

Determining payment information for the set of items S300 functions to obtain information that can be used to bill the user (e.g., customer). S300 can be performed before S100, concurrently with S100, after S100, before S200, concurrently with S200, after S200, before S400, concurrently with S400, and/or otherwise timed. The payment information can be received from the POS system, by the system, and/or any other suitable source. The payment information can be received: after item insertion into the measurement volume, after an item is detected within the measurement volume, while an item is detected within the measurement volume, after item removal from the measurement volume, after a checkout indication is received, after a payment prompt is displayed (e.g., on a customer display 160, on a cashier display 160, etc.), after an initial item is identified, after a final item is identified, before a checkout condition is satisfied, after a checkout condition is satisfied, and/or at any other suitable time. S300 is preferably performed automatically, but can alternatively be performed manually and/or otherwise performed.

In a first example, the user can be prompted to pay when items are detected or identified within the measurement volume. In a second example, the user can be prompted to pay after the user selects a button indicating that there are no new items to add (e.g., no additional item batches to add to the invoice). In a third example, the user (e.g., customer) can be prompted to pay after another user (e.g., cashier) selects a button indicating that there are no new items to add.

However, determining payment information for the set of items S300 may be otherwise performed.

Completing a transaction based on the payment information S400 functions to charge for the items on the invoice (e.g., invoice for the items, billing for the items, complete payment for the items, and/or any other suitable charging methods). S400 is preferably performed after S300, but can alternatively be performed concurrently with S300, before S300, and/or at any other suitable timing relative to S300. The transaction can be completed: after payment information received, after a checkout condition (e.g., a stop condition, a selection of a “checkout” button by a user, a receipt of payment information, a threshold duration since items were detected within the measurement volume, etc.) is satisfied, and/or at any other suitable time. S400 is preferably performed using the payment information (e.g., determined in S300), but can alternatively be performed using any other suitable information. S400 is preferably performed automatically, but can alternatively be performed manually, and/or otherwise performed.

The examples of completing a transaction based on the payment information S400 can include prompting a cashier (e.g., on a cashier display 160) to receive cash from a user, generating and sending a credit and/or debit card transaction for a total invoice amount to payment processor, generating and broadcasting a cryptocurrency transaction for a total invoice amount to a blockchain, and/or any other method of completing a transaction.

However, completing a transaction based on the payment information S400 may be otherwise performed.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken line in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system 180, cause the processing system 180 to perform the method(s) discussed herein. The instructions can be executed by computer-executable components integrated with the computer-readable medium and/or processing system 180. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system 180 (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A kiosk system, comprising:
a static base;
a set of supports mounted offset from opposing regions of the base, wherein the set of supports cooperatively define a measurement volume with the base,
wherein the measurement volume comprises a physically unenclosed top;
a set of optical sensors mounted to each support of the set of supports, wherein the set of optical sensors are directed toward the measurement volume and comprise fixed fields of view, wherein the fields of view of the set of optical sensors cooperatively encompasses an entirety of the base; and
a processing system configured to automatically identify a set of items based on a set of measurements from the set of optical sensors.

2. The system of claim 1, wherein an optical sensor of the set of optical sensors comprises a stereo camera pair.

3. The system of claim 1, wherein the set of measurements comprises a height map.

4. The system of claim 1, wherein automatically identifying the set of items based on the set of measurements comprises:
segmenting the set of measurements into a set of item segments;
determining a set of item embeddings based on the set of item segments; and
determining an item identifier for each item using the set of item embeddings.

5. The system of claim 4, wherein the set of item embeddings comprises an appearance embedding and a geometric embedding for each item.

6. The system of claim 1, wherein the set of supports consists essentially of two supports.

7. The system of claim 1, wherein the set of supports each comprise a post and an arm extending laterally from the respective post, wherein each arm comprises a first subset of optical sensors mounted proximal a joint between the post and the arm, and comprises a second subset of optical sensors mounted proximal an arm end.

8. The system of claim 1, wherein the measurement volume has an unobstructed front, back, left, and right side.

9. The system of claim 1, wherein the base comprises a display that displays an item indicator for an item of the set of items.

10. The system of claim 1, wherein the set of optical sensors cooperatively define an optically enclosed space, wherein the measurement volume is fully encompassed by the optically enclosed space.

11. A system, comprising:
a base;
a set of supports mounted to the base, wherein each support in the set of supports comprise a set of optical sensors;
a measurement volume geometrically defined by the base and the set of supports,
wherein the measurement volume comprises an unobstructed top, front, back, left, and right side; and
a processing system configured to identify objects based on a set of measurements of the measurement volume sampled by the set of optical sensors.

12. The system of claim 11, wherein the optical sensors define an optically enclosed space, wherein the measurement volume is encompassed within the optically enclosed space.

13. The system of claim 11, wherein the set of supports consists of a single support.

14. The system of claim 11, wherein the set of supports consists of two supports, wherein the two supports are mounted to a same side of the base.

15. The system of claim 11, wherein the set of optical sensors consists essentially of four static cameras.

16. The system of claim 11, wherein the base comprises an interactive display configured to display:
a calibration pattern when the system is in a calibration mode; and
a set of item indicators around each of a set of identified items when the system is in an item identification mode.

17. The system of claim 11, further comprising a set of user interfaces mounted to the set of supports, wherein different user interfaces are mounted to different supports at exterior regions of the respective supports, wherein the exterior regions are oriented away from base.

18. The system of claim 11, wherein the processing system identifies objects by:
segmenting the set of measurements into a set of item segments;
extracting a set of item embeddings for each item from the respective item segments;
identifying each item based on the respective set of item embeddings.

19. The system of claim 18, wherein segmenting the set of measurements comprises:
segmenting a geometric measurement of the set of measurements into a set of
geometric item segments using a set of heuristics; and
projecting the set of geometric item segments into an image to determine a set of image item segments; wherein the set of item embeddings comprises geometric embeddings extracted from the set of geometric item segments and appearance embeddings extracted from the set of image item segments.

20. The system of claim 11, further comprising a set of guard sensors, wherein the system is operable between a sleep and awake mode based on measurements sampled by the set of guard sensors.
